(19) United States
(12) Patent Application Publication
(10) Pub. No.: US 2014/0205402 A1
(43) Pub. Date: Jul. 24, 2014

(54) A HANDLING INSTALLATION FOR HANDLING FLAT ARTICLES STACKED ON EDGE, AND A METHOD OF UNLOADING FLAT ARTICLES STACKED ON EDGE

(71) Applicant: Solystic, Gentilly Cedex (FR)

(72) Inventors: Arnaud Caron, Valence (FR); Damien Hugues, Bourg Les Valence (FR); Benoit Chidaine, Villeurbanne (FR); Mickael Dauvergne, Mercurol (FR)

(21) Appl. No.: 13/819,890

(22) PCT Filed: Nov. 14, 2012
(86) PCT No.: PCT/FR2012/052623

§ 371 Date: Feb. 28, 2013

(30) Foreign Application Priority Data
Dec. 23, 2011 (FR) 1162390

(51) Int. Cl. B65G 49/00

(52) U.S. Cl. CPC B65G 49/00
USPC 414/373; 414/809

(57) ABSTRACT

A handling installation (1) for handling flat articles (2) stacked on edge and a loading method, the handling installation (1) including a transport trolley (300) provided with a box (303) having an inclined bottom wall (307), an end wall (306) facing which an opening (304) is provided, first and second storage units (100, 200) respectively having a loading zone (101) and a storage zone (201), and an unloading zone (203) provided upstream from said storage zone (201) and mounted to move between a transfer position in which it is coplanar with said storage zone (201) and an unloading position in which it is coplanar with said bottom wall (307).

### TECHNICAL FIELD

The invention relates generally to a handling installation for handling flat articles stacked on edge, the handling installation including at least one first storage unit and at least one second storage unit, a transport trolley provided with at least one box suitable for receiving said flat articles so as to transport them between said first and second storage units, said first and second storage units respectively having at least one loading zone and at least one storage zone, said loading zone being suitable for receiving a stack of flat articles on edge before they are transported, and said storage zone being suitable for receiving a stack of flat articles on edge after they are transported, said box having a bottom wall from which at least one end wall extends, facing which at least one opening is provided.

The invention also relates to an unloading method for unloading flat articles stacked on edge, during which, prior to being transported, the stack of flat articles is stored in a loading zone, then said stack of flat articles is loaded onto a transport trolley provided with at least one box suitable for receiving said flat articles stacked on edge, and having a bottom wall from which at least one end wall extends, facing which an opening is provided, then said stack of flat articles is transported by means of said trolley, said stack of flat articles is unloaded and it is placed in a storage zone.

In the meaning of the invention, a “flat article” means, particularly but not exclusively, a mailpiece. Mailpieces that are suitable for being stacked using the handling installation of the invention may be of various sizes, and they may also have a variety of mechanical characteristics, in particular as regards stiffness. Such a mailpiece may, inter alia, be an ordinary letter, a magazine, an envelope with or without a window, a newspaper, or indeed a catalog wrapped in plastic or in paper, with or without gussets.

### PRIOR ART

In known manner, installations for handling flat articles stacked on edge are encountered, for example, in postal sorting centers. Such a handling installation comprises storage units between which the stacked flat articles are moved, e.g. using trays or trolleys. The stacks of flat articles must also be loaded manually from a first storage unit onto the transport trolley and then unloaded from the transport trolley onto the second storage unit, before they can be transferred towards a handling zone, e.g. a zone for sorting the flat articles. These manipulations of stacks of flat articles on edge are laborious and repetitive, and they require movements that are not ergonomic, hence efficiency is low and handling costs are high.

### SUMMARY OF THE INVENTION

An object of the invention is to remedy those drawbacks by proposing a handling installation for handling flat articles stacked on edge and an unloading method for unloading flat articles stacked on edge that facilitate manipulating the stacks of flat articles on edge and transferring said stacks of articles by means of a transport trolley between two storage units.

To this end, the invention provides a handling installation for handling flat articles stacked on edge, the handling installation including at least one first storage unit and at least one second storage unit, a transport trolley provided with at least one box suitable for receiving the flat articles so as to transport them between the first and second storage units, the first and second storage units respectively having at least one loading zone and at least one storage zone, the loading zone being suitable for receiving a stack of flat articles on edge before they are transported, and the storage zone being suitable for receiving a stack of flat articles on edge after they are transported, the box having a bottom wall from which at least one end wall extends, facing which at least one opening is provided, the handling installation being characterized in that the bottom wall is inclined so that the stack of articles bears against the end wall by gravity, in that the handling installation has at least one unloading zone provided upstream from the storage zone, the unloading zone being suitable for receiving the flat articles on edge and being mounted to move between a transfer position in which it is substantially coplanar with the storage zone and an unloading position in which it is designed to be substantially coplanar with the bottom wall of the transport trolley as placed so that its end wall is facing the unloading zone, opposite from the storage zone.

The basic idea of the invention is to provide an intermediate unloading zone between the transport trolley and the storage zone, this unloading zone being mounted to move so as to adapt to match, in succession, the position of the flat articles in the trolley and then their position in the storage zone. Thus, the unloading zone makes it possible to limit the movements of the operator for unloading the flat articles, and makes it possible to achieve higher efficiency in handling the flat articles.

The handling installation of the invention may advantageously have the following features:
it may have at least one extraction bar coupled to the unloading zone relative to which it is mounted to move in translation between a retracted position in which it is retracted at least in part under the unloading zone and a deployed position in which it extends beyond the unloading zone opposite from the storage zone, it being possible for the bottom wall to be provided with at least one bottom groove suitable for receiving the extraction bar between its retracted and deployed positions so that the extraction bar passes under the flat articles stacked in the box, it being possible for the end wall to be provided with at least one end slot extending from the bottom wall and opening out at the top of the end wall, the end slot being suitable for allowing the extraction bar to go between its retracted and deployed positions and between the transfer and unloading positions of the unloading zone;
it may have at least one abutment coupled to move in translation with the extraction bar and mounted to move between an inactive position in which the front abutment is retracted at least in part under the unloading zone and an active position in which the front abutment projects above the unloading zone so as to serve as a bearing surface at the front of the stack of flat articles;
the unloading zone is provided with at least one through unloading slot provided facing the extraction bar so that the extraction bar is suitable for at least coming flush with the unloading zone when the extraction bar is in the retracted position, the unloading slot allowing the front abutment to go into its active position when the extraction bar is between its retracted and deployed positions;
the second storage unit is provided with at least one main paddle mounted to move in translation, in a plane substantially parallel to the storage zone, between a prior-to-unloading position in which it is suitable for being pressed behind the stack of flat articles carried by a transport trolley placed facing the unloading zone and a transfer position in which it is above the storage zone; and
the free end of the loading zone of the first storage unit facing which the transport trolley can be placed is provided at a first height at least equal to the second height of the base of the opening of the box so that the stack of flat articles can be loaded into the box without being lifted.

The invention also provides an unloading method for unloading flat articles stacked on edge, during which, prior to being transported, the stack of flat articles is stored in a loading zone, then the stack of flat articles is loaded onto a transport trolley provided with at least one box suitable for receiving the flat articles stacked on edge, and having a bottom wall from which at least one end wall extends, facing which an opening is provided, then the stack of flat articles is transported by means of the trolley, the stack of flat articles is unloaded and it is placed in a storage zone, the method being characterized in that a transport trolley is used in which the bottom wall is inclined so that the stack of flat articles bears against the end wall by gravity, in that, in order to unload the flat articles from the transport trolley an unloading zone is used that is provided upstream from the storage zone, in that the transport trolley is placed so that its end wall is facing the free end of the unloading zone that is opposite from the storage zone, and in that the unloading zone is inclined from a transfer position in which it is substantially coplanar with the storage zone to an unloading position in which it is substantially coplanar with the bottom wall of the transport trolley.

The unloading method of the invention may advantageously have the following features:
at least one extraction bar is used that is coupled to the unloading zone and that is moved in translation between a retracted position in which it is retracted at least in part under the unloading zone and a deployed position in which it extends beyond the unloading zone opposite from the storage zone, a box is used in which the bottom wall is provided with at least one bottom groove suitable for receiving the extraction bar between its retracted and deployed positions so that the extraction bar passes under the flat articles stacked in the box, a box is used in which the end wall is provided with at least one end slot extending from the bottom wall and opening out at the top of the end wall, the end slot being suitable for allowing the extraction bar to go between its retracted and deployed positions and between the transfer and unloading positions of the unloading zone, and in that the following steps are performed in succession:
   a first movement of said unloading zone from its transfer position to its unloading position;
   with said unloading zone in the unloading position, a first movement in translation of the extraction bar from its retracted position to its deployed position so that the extraction bar passes through the end slot and is received in the bottom groove so as to go under the flat articles stacked in the box;
   a second movement of the unloading zone from its unloading position to its transfer position, the extraction bar being in its deployed position and sliding in the end slot by disengaging from the bottom groove in such a manner as to lift the stack of flat articles;
   a second movement in translation of the extraction bar carrying the stack of flat articles from its deployed position to its retracted position with a simultaneous movement in translation of the stack of flat articles towards the unloading zone; and
   a final transfer of the stack of flat articles from the unloading zone to the storage zone;
during the step of the second movement of the unloading zone and during the step of the second movement in translation of the extraction bar, the front of the stack of flat articles is retained and accompanied by means of a front abutment, and, in order to perform the step of the final transfer of the stack of flat articles towards the storage zone, the front abutment is retracted; and
during the step of the second movement of the unloading zone, during the step of the second movement in translation of the extraction bar, and during the step of the final transfer of the stack of flat articles towards the storage zone, the back of the stack of flat articles is retained and accompanied by means of a main paddle that is mounted to move in translation.

### BRIEF DESCRIPTION OF THE DRAWINGS

The present invention can be better understood and other advantages appear on reading the following detailed description of an embodiment given by way of non-limiting example and with reference to the accompanying drawings, in which:

FIG. 1 is a side view of a portion of the handling installation of the invention including a first storage unit and a transport trolley, this figure showing the step of loading the flat articles stacked on edge from the first storage unit to the transport trolley;

FIGS. 2 to 9 are perspective views of a portion of the handling installation of the invention including a second storage unit and the transport trolley, these figures showing the steps of unloading the flat articles stacked on edge from the transport trolley to the second storage unit;

FIGS. 10 to 17 are diagrammatic side views of the portion of the handling installation of FIGS. 2 to 9, showing the successive steps of the method of the invention for unloading the flat articles, from the transport trolley to the second storage unit; and

FIG. 18 is a perspective view of a transport trolley of the handling installation of the invention.

### DESCRIPTION OF THE EMBODIMENT

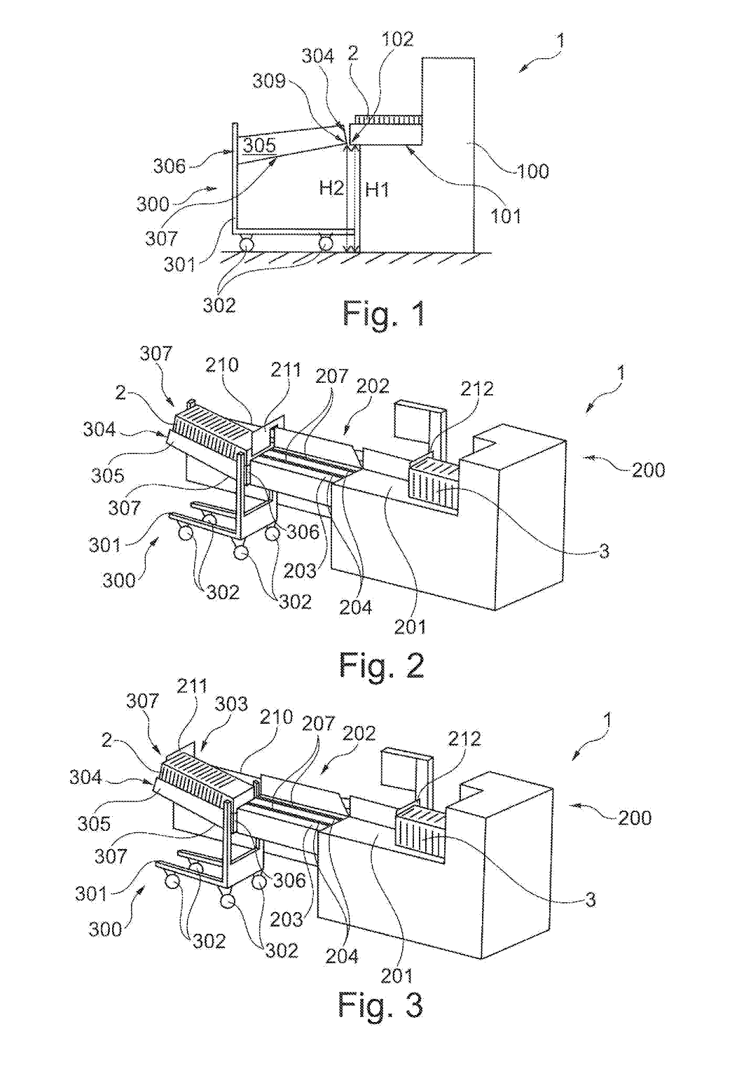

With reference to FIGS. 1 to 18, the handling installation 1 for handling flat articles 2 stacked on edge includes a first storage unit 100 (FIG. 1), a second storage unit 200 (FIGS. 2 to 17), and a transport trolley 300 (FIGS. 1 to 18).

With reference, in particular, to FIG. 18, the transport trolley 300 of the invention is of the wheeled trolley type. The transport trolley may also be of any other type. The transport trolley 300 has a framework 301 carried by four wheels 302 and a box 303 carried by the framework 301 and suitable for receiving flat articles 2, stacked on edge, for the purpose of transporting them between the first storage unit 100 and the second storage unit 200. The box 303 has a bottom wall 307 from which two side walls 305 extend that are interconnected by an end wall 306 facing which an opening 304 is provided. The bottom wall 307 is designed to receive the edges of the flat articles 2, and the end wall 306 is designed to receive the face of the flat article 2 at the front of a stack of flat articles 2. The side walls 305 make it possible to ensure that the stack of flat articles 2 are properly settled and are held within the box 303 while the transport trolley 300 is moving.

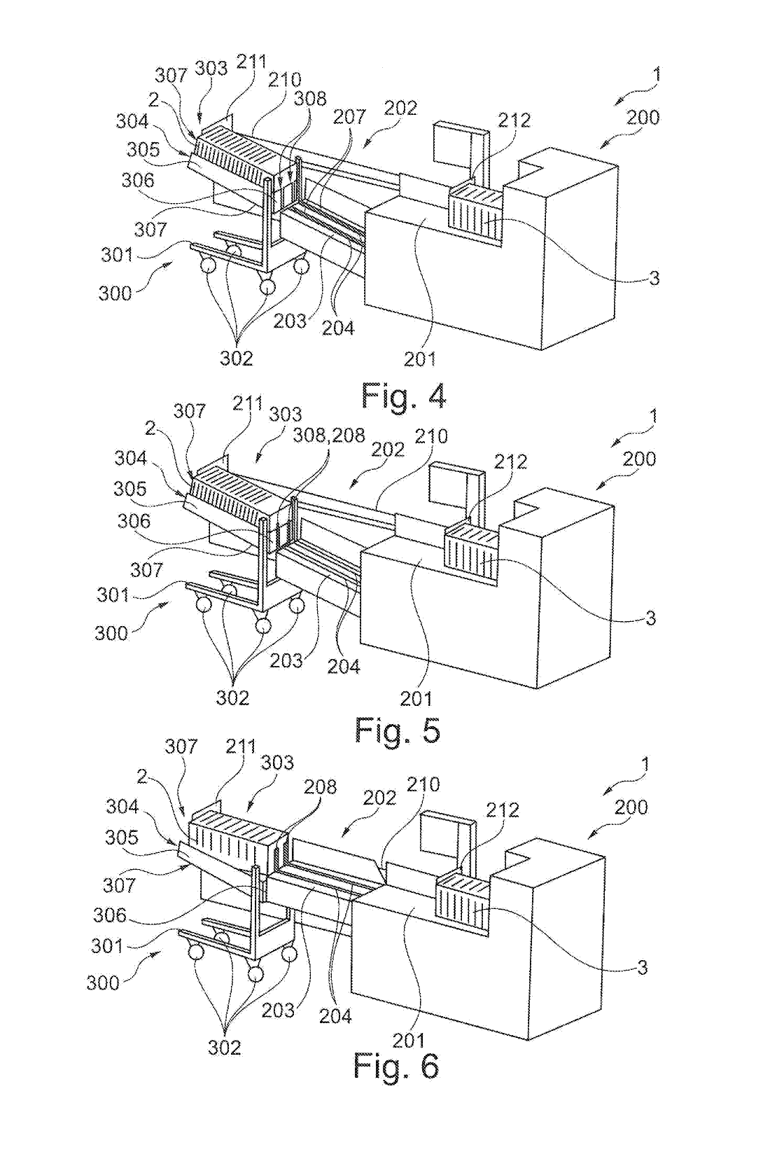

In the example shown, the end wall 306 is provided with two end slots 308 (shown in FIGS. 4, 5, and 18) extending from the bottom wall 307 and opening out in the top of the end wall 306. These end slots 308 are substantially parallel to each other and are perpendicular to the bottom wall 307. As explained in detail below, these end slots 308 are suitable for allowing extraction bars to pass through into the box 303 for extracting the stacked flat articles 2 therefrom. In a variant embodiment (not shown), the end wall may be provided with a single end slot or with a larger number of end slots co-operating respectively with a single extraction bar or with a plurality of extraction bars.

The bottom wall 307 is inclined at an angle α (shown in detail in FIG. 18) relative to a horizontal plane so that a stack of flat articles 2 on edge received in the box 303 is pressed by gravity against the end wall 306, improving the stability of the stack of flat articles 2 and limiting the risks of the flat articles 2 tipping or slipping out of the box 303. For example, the angle α lies in the range 9° to 11°, and is preferably equal to 10°. In addition, the bottom wall 307 is provided with two bottom grooves 310 (shown in FIG. 18) and with one central groove 311, these grooves being substantially mutually parallel and perpendicular to the end wall 306. The bottom grooves 310 are provided in alignment with the end slots 308. Thus, as explained in detail below, these bottom grooves 310 are suitable for receiving extraction bars that are inserted into the box 303 for extracting the stacked flat articles 2. The central groove 311 provided between the bottom grooves 310 has a width greater than the width of the bottom grooves 310 so as to allow the hand of an operator to pass through for accompanying the flat articles 2 while the transport trolley 300 is being filled. In a variant embodiment (not shown), the bottom wall may be provided with a larger number of bottom grooves co-operating with a plurality of extraction bars. In addition, the bottom grooves may be in the form of slots passing through bottom wall.

At least two of the four wheels 302 of the transport trolley 300 may be swivel wheels. In addition, the box 303 may be mounted to move between a working position in which it is suitable for receiving the stack of flat articles 2 for transporting them, and a resting position (not shown) in which it is tipped against the vertical uprights of the framework 301 so as to make the transport trolley 300 more compact. In advantageous manner, the handling installation 1 of the invention includes a plurality of transport trolleys 300. The frameworks 301 of the transport trolleys 300 are preferably arranged to be substantially trapezoid in shape so as to allow the transport trolleys 300 to nest together to form a train of resting trolleys when the boxes 303 are in their resting positions. The transport trolleys 300 may be provided with first anchor means (not shown) suitable for securing the transport trolleys 300 together so as to form a train of resting trolleys when the boxes 303 are in their resting positions. The transport trolleys 300 may also be provided with second anchor means (not shown) suitable for securing the transport trolleys 300 together so as to form a train of working trolleys when the boxes 303 are in their working positions. The transport trolleys 300 can thus be moved as a train of working trolleys or as a train of resting trolleys. In order to facilitate such grouped movements of transport trolleys 300, some of the swivel wheels 302 may be temporarily prevented from being free to swivel by any suitable means. In addition, one or more wheels 302 of each transport trolley 300 may be equipped with a brake (not shown) making it possible to hold the transport trolley 300 stationary at any specific place. Finally, the transport trolleys 300 may be provided with anchor means (not shown) suitable for securing the transport trolley 300 to the first storage unit or to the second storage unit 100, 200 respectively while the stack of flat articles 2 is being loaded into the box 303 and while it is being unloaded therefrom.

With reference to FIG. 1, the first storage unit 100 includes a loading zone 101 suitable for receiving a stack of flat articles 2 on edge, before they are loaded on a transport trolley 300. For example, this loading zone 101 is horizontal. It may also be inclined. The free end 102 of the loading zone 101, facing which a transport trolley 300 can be placed for the purpose of loading the flat articles 2 into its box 303, is provided at a first height H1 (shown in FIG. 1) at least equal to the second height H2 (shown in FIG. 1) of the low edge 309 of the opening 304. Thus, the edges of the flat articles 2 stored in the loading zone 101 are at a height at least equal to the height of the end of the bottom wall 307, allowing the stacked flat articles 2 to be loaded by being slid from the loading zone 101 into the box 303, without them needing to be lifted.

With reference to FIGS. 2 to 17, the second storage unit 200 includes a storage zone 201 suitable for receiving the stack of flat articles 2 on edge, after said stack has been transported by the transport trolley 300 and after said stack has been unloaded. The second storage unit 200 includes an unloading module 202 provided with an unloading zone 203 suitable for receiving the stack of flat articles 2 on edge unloaded from the transport trolley 300 and for moving them towards the storage zone 201. This unloading zone 203 may have two unloading slots 204 that are substantially mutually parallel and that have a function that is described in detail below. The loading module 202 is mounted to move between a transfer position (shown in FIGS. 2, 3, 6 to 11, and 14 to 17) in which the unloading zone 203 is substantially coplanar with the storage zone 201 and an unloading position (shown in FIGS. 4, 5, 12, and 13) in which the unloading zone 203 is substantially coplanar with the bottom wall 307 of a transport trolley 300 placed facing the unloading zone 203. Thus, in the transfer position, the stacked flat articles 2 present in the loading zone 203 can be moved towards the storage zone 201 merely by being slid.

With reference to FIGS. 10 to 17, the unloading module 202 has a block 209 mounted to slide on two guide rods 205 relative to which the block 209 is moved, e.g. by means of threaded rod 206 of the motor-driven endless type and by means of a nut (not shown) coupled to the block 209. In addition, the unloading module 202 has two extraction bars 207 that are substantially parallel to each other and to the unloading zone 203, and that are carried by the block 209. The extraction bars 207 are thus mounted to move in translation relative to the guide rods 205 between a retracted position (visible in FIGS. 2 to 4, 7 to 12 and 15 to 17) in which they are retracted under the unloading zone 203 and a deployed position (shown in FIGS. 5, 6, 13 and 14) in which they extend beyond the unloading zone 203. The extraction bars 207 are provided facing the unloading slots 204 so that the extraction bars 207 are individually flush with the unloading zone 203 through the unloading slots 204.

The unloading module 202 is also provided with two front abutments 208 carried by the block 209 and provided facing the unloading slots 204. The front abutments 208 are mounted to move relative to the block 209 between an inactive position in which they are retracted under the unloading zone 203 and an active position in which they project above the unloading zone 203, substantially perpendicularly to the unloading zone 203. The front abutments 208 are coupled to move in translation with the extraction bars 207. Thus, as explained in detail below, they serve as a bearing surface for the front of the stack of flat articles 2 while said stack is being unloaded towards the storage zone 201.

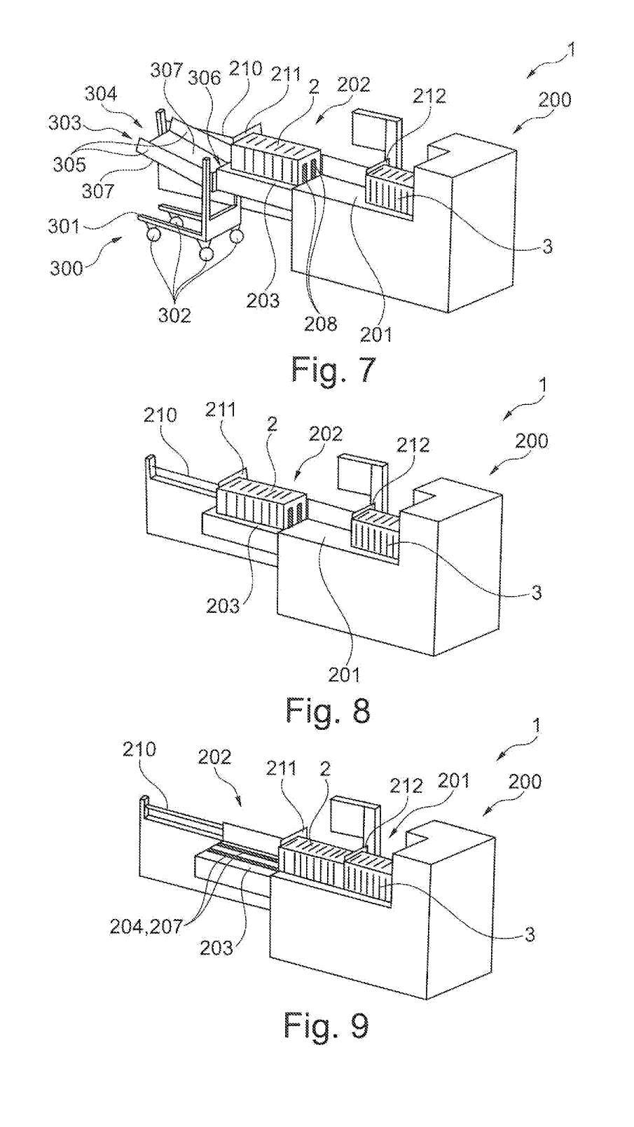

The second storage unit 200 also has a slideway 210 (visible in FIGS. 2 to 9) extending parallel to the storage zone 201, from upstream from the transport trolley 300 placed facing the unloading zone 203 towards the storage zone 201. This slideway 210 carries a main paddle 211 that is mounted to move in translation between a prior-to-unloading position (shown in FIGS. 3 to 6 and 13 & 14) in which it is at the back of the stack of flat articles 2 carried by the transport trolley 300, and a transfer position (shown in FIG. 9) in which it is above the unloading zone, via an intermediate position (shown in FIGS. 7 and 8, and 15 to 17).

With reference to FIG. 1, the flat articles 2 can be stored in the loading zone 101 of the first storage unit 100. A transport trolley 300 as described above is used for transferring the stack of flat articles 2 from the first storage unit 100 to the second storage unit 200. In order to load the stack of flat articles 2 onto the transport trolley 300, the transport trolley 300 is placed in front of the loading zone 101 so that the opening 304 of the box 303 is directly facing the loading zone 101. By sliding or by carrying and sliding, the flat articles 2 stacked in the loading zone 101 are moved into the box 303. Once inside the box 303, the stack of flat articles 2 is pressed by gravity against the end wall 306. The stacked flat articles 2 are then transported to the second storage unit 200.

The steps of the unloading method of the invention for unloading the stack of flat articles 2 transported by the transport trolley 300 to the storage zone 203 of the second storage unit 200 are described below.

With reference to FIGS. 2 and 10, a preceding stack of flat articles 3 can be stored in the storage zone 201 of the second storage unit 200, the back of said preceding stack of flat articles 3 being held by a secondary paddle 212. The transport trolley 300 is placed in front of the unloading zone 203 so that the end wall 307 of the box 303 is directly facing the unloading zone 203. In this configuration, the unloading zone 203 is in its transfer position, the extraction bars 207 are in their retracted positions, the front abutments 208 are in their inactive positions, and the main paddle 211 is in its intermediate position.

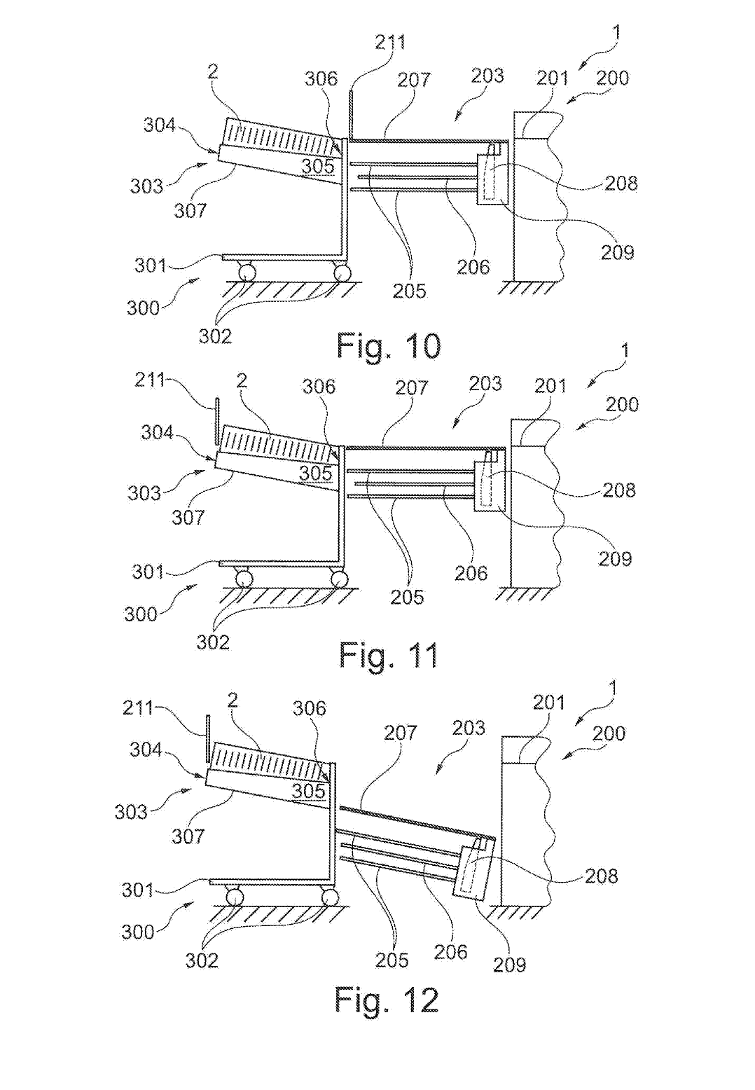

With reference to FIGS. 3 and 11, the main paddle 211 is moved from its intermediate position to its prior-to-unloading position. In the configuration obtained after this movement, the unloading zone 203 is in its transfer position, the extraction bars 207 are in their retracted positions, and the front abutments 208 are in their inactive positions.

With reference to FIGS. 4 and 12, the unloading zone 203 is moved in a first movement from its transfer position to its unloading position so that the unloading zone 203 is substantially coplanar with the bottom wall 307 of the box 303, the extraction bars 207 facing the bottom grooves 310. In the configuration obtained after this movement, the extraction bars 207 are in their retracted positions, the front abutments 208 are in their inactive positions, the main paddle 211 is in its prior-to-unloading position in which it retains the back of the stack of flat articles 2.

With reference to FIGS. 5 and 13, the front abutments 208 are moved from their inactive position towards their active position and, simultaneously or successively, the block 209 carrying the extraction bars 207 and the front abutments 208 is moved in a first movement in translation from its retracted position to its deployed position. During this step, the extraction bars 207 penetrate into the box 303. They pass through the end slots 308 and are received progressively in the bottom grooves 310 by passing between the bottom wall 307 and the edges of the stacked flat articles 2 bearing against the bottom wall 307. The front abutments 208 pass through the unloading slots 204 so as to be suitable for retaining the front of the stack of flat articles 2. In the configuration obtained after this movement, the extraction bars 207 are under the stacked flat articles 2, the unloading zone 203 is in its unloading position, the front abutments 208 are in their active positions in which they are suitable for retaining the front of the stack of flat articles 2, and the main paddle 211 is in its prior-to-unloading position in which it retains the back of the stack of flat articles 2.

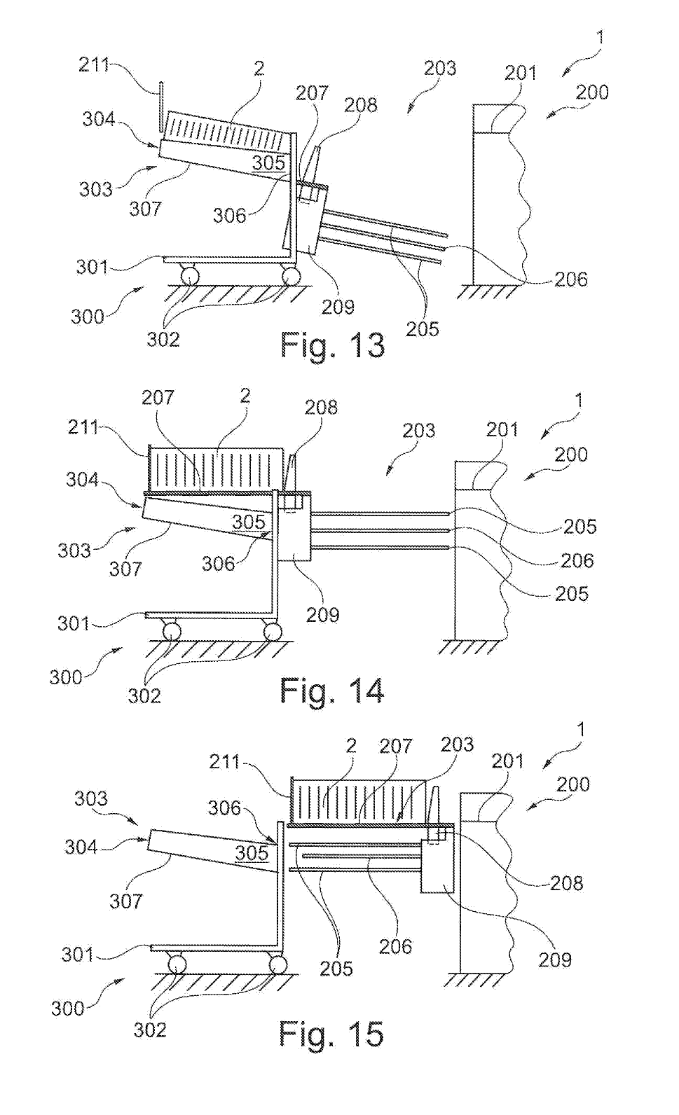

With reference to FIGS. 6 and 14, the unloading zone 203 is moved in a second movement from its unloading position to its transfer position so that the flat articles 2 are bearing against the extraction bars 207, while being held at the back by the main paddle 211 and at the front by the front abutments 208. During this movement, the extraction bars 207 move through the end slots 308, the front abutments 208 accompany and retain the front of the stack of flat articles 2, and the main paddle 211 retains the back of the stack of flat articles 2. In the configuration obtained after this movement, the extraction bars 207 are in their deployed positions, the front abutments 208 are in their active positions, and the main paddle 211 is in its prior-to-unloading position.

With reference to FIGS. 7 and 15, the block 209 carrying the extraction bars 207 and the front abutments 208 is moved in a second movement in translation from the deployed position to the retracted position so as to move the stacked flat articles 2 towards the top of the unloading zone 203. During this second movement in translation, the back of the stack of flat articles 2 is accompanied by means of the main paddle 211 at the back of said stack of flat articles 2 which is retained while the main paddle 211 is going from its prior-to-unloading position to its intermediate position. The front of the stack is accompanied and retained by means of the front abutments 208. In the configuration obtained after this movement, the unloading zone 203 is in its unloading position, the extraction bars 207 are in their retracted position, the front abutments 208 are in their active position, and the main paddle 211 is in its intermediate position.

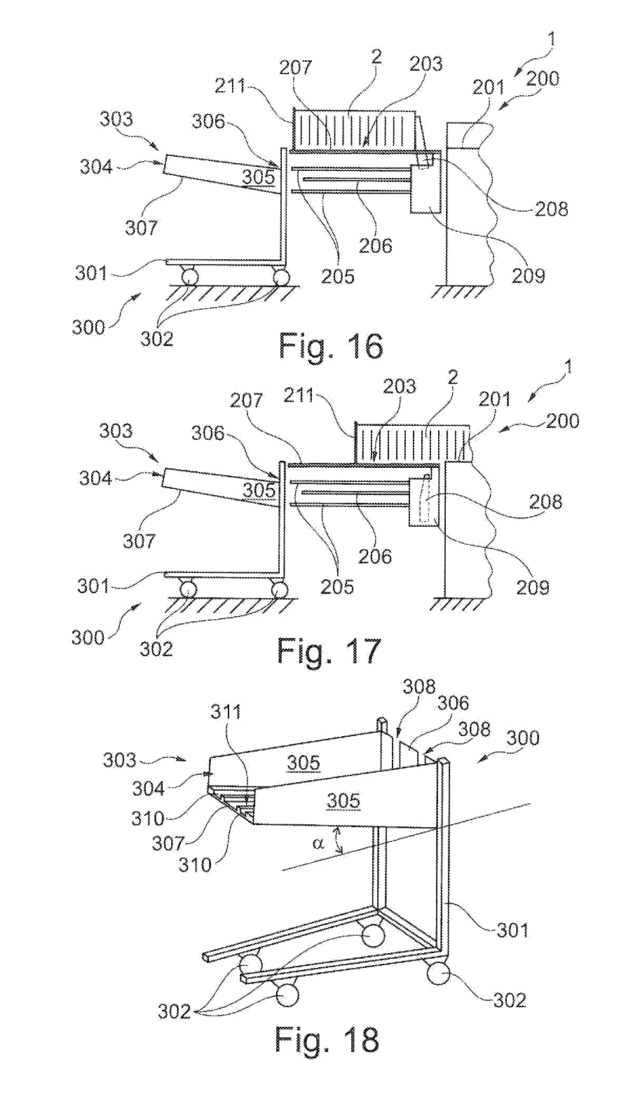

With reference to FIG. 16, the front abutments 208 are inclined so as to incline the front of the stack of flat articles 2 so as to facilitate stacking it properly with a preceding stack of flat articles 3 already present in the storage zone 201. This step is optional and the stack of flat articles 3 may be moved towards the preceding stack of flat articles 3 without being inclined first.

With reference to FIG. 8, the front abutments 208 are retracted by causing them to go from their active position to their inactive position.

With reference to FIG. 17, a final transfer is performed by moving the stack of flat articles 2 from the unloading zone 203 towards the storage zone 201, above the retracted front abutments 208, until the configuration of FIG. 9 is reached, in which the stack of flat articles 2 lies fully within the storage zone 201, behind a secondary paddle 212 retaining the preceding stack of flat articles 3. In this configuration, the unloading zone 203 is in its transfer position, the extraction bars 207 are in their retracted position, the front abutments 208 are in their inactive position, and the main paddle 211 is in its transfer position.

Then, the secondary paddle 212 is removed from between the two stacks of flat articles 2, 3 and it is placed behind the stack of flat articles 2 that has just been received in the storage zone 201 and the main paddle 211 is moved from its transfer position to its intermediate position. The handling installation 1 is then ready to receive another stack of flat articles transported by a transport trolley 300.

In an advantageous embodiment that is not shown, the end wall is provided with four through end slots and the loading module of the second storage unit includes four extraction bars suitable for passing through the slots for the purpose of unloading the flat articles from the box. The weight of the flat articles can thus be distributed over the four extraction bars, thereby limiting the risks of said flat articles being damaged.

The handling installation 1 of the invention advantageously includes motor-driven means for moving the unloading zone 203, the block 209, and optionally the main paddle 211. It makes it easy to transfer a stack of flat articles 2 from the first storage unit 100 to the transport trolley 300 and from the transport trolley 300 to the second storage unit 200 by facilitating the movements of the operator, limiting the efforts the operator needs to make, and enabling them to be made under better ergonomic conditions. The unloading method is thus more reliable and of higher efficiency.

1. A handling installation (1) for handling flat articles (2) stacked on edge, the handling installation (1) including at least one first storage unit (100) and at least one second storage unit (200), a transport trolley (300) provided with at least one box (303) suitable for receiving said flat articles (2) so as to transport them between said first and second storage units (100, 200), said first and second storage units (100, 200) respectively having at least one loading zone (101) and at least one storage zone (201), said loading zone being suitable for receiving a stack of flat articles (2) on edge before they are transported, and said storage zone being suitable for receiving a stack of flat articles (2) on edge after they are transported, said box (303) having a bottom wall (307) from which at least one end wall (306) extends, facing which at least one opening (304) is provided, said handling installation being characterized in that said bottom wall (307) is inclined so that said stack of articles (2) bears against said end wall (306) by gravity, in that said handling installation (1) has at least one unloading zone (203) provided upstream from said storage zone (201), said unloading zone (203) being suitable for receiving said flat articles (2) on edge and being mounted to move between a transfer position in which it is substantially coplanar with said storage zone (201) and an unloading position in which it is designed to be substantially coplanar with said bottom wall (307) of the transport trolley (300) as placed so that its end wall (306) is facing said unloading zone (203), opposite from said storage zone (201).

2. The handling installation (1) according to claim 1, characterized in that it has at least one extraction bar (207) coupled to said unloading zone (203) relative to which it is mounted to move in translation between a retracted position in which it is retracted at least in part under said unloading zone (203) and a deployed position in which it extends beyond said unloading zone (203) opposite from said storage zone (201), in that said bottom wall (307) is provided with at least one bottom groove (310) suitable for receiving said extraction bar (207) between its retracted and deployed positions so that said extraction bar (207) passes under said flat articles (2) stacked in said box (303), in that said end wall (306) is provided with at least one end slot (308) extending from said bottom wall (307) and opening out at the top of the end wall (306), said end slot (308) being suitable for allowing said extraction bar (207) to go between its retracted and deployed positions and between said transfer and unloading positions of said unloading zone (203).

3. The handling installation (1) according to claim 2, characterized in that it has at least one abutment (208) coupled to move in translation with said extraction bar (207) and mounted to move between an inactive position in which said front abutment (208) is retracted at least in part under said unloading zone (203) and an active position in which said front abutment (208) projects above said unloading zone (203) so as to serve as a bearing surface at the front of said stack of flat articles (2).

4. The handling installation (1) according to claim 3, characterized in that said unloading zone (203) is provided with at least one through unloading slot (204) provided facing said extraction bar (207) so that said extraction bar (207) is suitable for at least coming flush with said unloading zone (203) when said extraction bar (207) is in said retracted position, said unloading slot (204) allowing said front abutment (208) to go into its active position when the extraction bar (207) is between its retracted and deployed positions.

5. The handling installation (1) according to claim 4, characterized in that said second storage unit (200) is provided with at least one main paddle (211) mounted to move in translation, in a plane substantially parallel to said storage zone (201), between a prior-to-unloading position in which it is suitable for being pressed behind said stack of flat articles (2) carried by a transport trolley (300) placed facing said unloading zone (203) and a transfer position in which it is above said storage zone (201).

6. The handling installation (1) according to claim 5, characterized in that the free end of said loading zone (101) of said first storage unit (100) facing which the transport trolley (300) can be placed is provided at a first height (H1) at least equal to the second height (H2) of the base of said opening (304) of said box (303) so that said stack of flat articles (2) can be loaded in said box (303) without being lifted.

7. An unloading method for unloading flat articles (2) stacked on edge, during which, prior to being transported, the stack of flat articles (2) is stored in a loading zone (101), then said stack of flat articles (2) is loaded onto a transport trolley (300) provided with at least one box (303) suitable for receiving said flat articles (2) stacked on edge, and having a bottom wall (307) from which an end wall (306) extends, facing which an opening (304) is provided, then said stack of flat articles (2) is transported by means of said trolley (300), said stack of flat articles (2) is unloaded and it is placed in a storage zone (201), said method being characterized in that a transport trolley (300) is used in which said bottom wall (307) is inclined so that said stack of flat articles (2) bears against said end wall (306) by gravity, in that, in order to unload said flat articles from said transport trolley (300) an unloading zone (203) is used that is provided upstream from said storage zone (201), in that said transport trolley (300) is placed so that its end wall (306) is facing the free end of said unloading zone (203) that is opposite from said storage zone (201), and in that said unloading zone (203) is inclined from a transfer position in which it is substantially coplanar with said storage zone (201) to an unloading position in which it is substantially coplanar with said bottom wall (307) of said transport trolley (300).

8. The unloading method according to claim 7, characterized in that at least one extraction bar (207) is used that is coupled to said unloading zone (203) and that is moved in translation between a retracted position in which it is retracted at least in part under said unloading zone (203) and a deployed position in which it extends beyond said unloading zone (203) opposite from said storage zone (201), in that a box (303) is used in which said bottom wall (307) is provided with at least one bottom groove (310) suitable for receiving said extraction bar (207) between its retracted and deployed positions so that said extraction bar (207) passes under said flat articles (2) stacked in said box (303), in that a box (303) is used in which said end wall (306) is provided with at least one end slot (308) extending from said bottom wall (307) and opening out at the top of the end wall (306), said end slot (308) being suitable for allowing said extraction bar (207) to go between its retracted and deployed positions and between said transfer and unloading positions of said unloading zone (203), and in that the following steps are performed in succession:
a first movement of said unloading zone (203) from its transfer position to its unloading position;
with said unloading zone (203) in said unloading position, a first movement in translation of said extraction bar (207) from its retracted position to its deployed position so that said extraction bar (207) passes through said end slot (308) and is received in said bottom groove (310) so as to go under said flat articles (2) stacked in said box (303);
a second movement of said unloading zone (203) from its unloading position to its transfer position, said extraction bar (207) being in its deployed position and sliding in said end slot (308) by disengaging from said bottom groove (310) in such a manner as to lift said stack of flat articles (2);
a second movement in translation of said extraction bar (207) carrying said stack of flat articles (2) from its deployed position to its retracted position with a simultaneous movement in translation of said stack of flat articles (2) towards said unloading zone; and
a final transfer of said stack of flat articles (2) from said unloading zone (203) to said storage zone (201).

9. The unloading method according to claim 8, characterized in that, during said step of the second movement of said unloading zone (203) and during said step of the second movement in translation of said extraction bar (207), the front of said stack of flat articles (2) is retained and accompanied by means of a front abutment (208), and in that, in order to perform said step of the final transfer of said stack of flat articles (2) towards said storage zone (201), said front abutment (208) is retracted.

10. The unloading method at least according to claim 8, characterized in that, during said step of the second movement of said unloading zone (203), during said step of the second movement in translation of said extraction bar (207), and during the step of the final transfer of said stack of flat articles (2) towards said storage zone (201), the back of said stack of flat articles (2) is retained and accompanied by means of a main paddle (211) that is mounted to move in translation.
